(19) United States
(12) Patent Application Publication
(10) Pub. No.: US 2006/0266773 A1
(43) Pub. Date: Nov. 30, 2006

(54) Dispensing cap

(75) Inventor: Istvan Lindmayer, Dobrokoz (HU)

Correspondence Address: BIRCH STEWART KOLASCH & BIRCH, PO BOX 747, FALLS CHURCH, VA, 22040-0747, US

(73) Assignee: Mayex USA Kft., Budapest (HU)

(21) Appl. No.: 10/553,425

(22) PCT Filed: Apr. 13, 2004
(86) PCT No.: PCT/HU04/00034

§ 371 Date: Aug. 2, 2006

(30) Foreign Application Priority Data
Apr. 18, 2003 (HU) U0300103
Apr. 18, 2003 (HU) P0303380

(51) Int. Cl. B67D 3/00

(52) U.S. Cl. 222/511

(57) ABSTRACT

A dispensing cap for bottles consisting of a lower mounting part fixed onto neck of bottle, an upper covering part containing the dispensing parts such as valve and opening members, sealing elements between the cap and the bottle for gas-proof sealing, outlet for pouring liquid, tube support for holding the tube of siphon structure and known completing elements if necessary, characterized by that it contains an irreversibly removable fixing member (27) preventing dispensing.

The subject-matter of the application is a dispensing cap for bottles consisting of a lower mounting part fixed onto neck of bottle, a cover containing the dispensing parts, sealing elements between the cap and the bottle for gas-proof sealing, outlet for pouring liquid, tube support for holding tube and known completing elements if necessary.

Soft drinks are usually sold in cans paper boxes or plastic bottles. Cans came into fashion with canned beer. Cans may not be dosed after opening so they are not very successful for soft drinks. Some types of paper boxes may be closed but their closing is not really safe and drinking from paper boxes is uncomfortable. A pouring tape or lip is necessary being not part of the box. A drinking straw is usually attached to small paper boxes but drinking is not enjoyable with it that's why customers prefer bottles from among all the types of packages. Bottles are provided with dosing caps mostly screw caps. There is an endeavor to diminish loss of carbon dioxide content of the rest part of carbonated soft drinks as much as possible to prevent loss of quality. For this purpose plastic dispensing heads similar to those of old soda water bottles are coming into use. One of such solutions is described in the Hungarian patent specification HU 210.579 and in the Hungarian utility model specification 30-U. These solutions have disadvantages that they make difficult storage of bottles increasing their height and their construction is too complicated and expensive for use once. They may be used several times only for soda water but not for flavored or fibrous drinks because of lack of proper cleaning. The Hungarian patent specification HU 214.254 relates to a plastic dispensing head closing the bottle dispensing the fluid content and being not higher than a simple screw cap. This solution provides a cheap disposable product for usage once but not protected against repeated usage. A safety ring dosing on the neck of bottle torn from the cap at first opening is used to show that the original bottle has been opened. This is not applicable for dispensing heads or caps because they are not taken from the bottle but dispense the liquid. The registered Hungarian utility model 1988-U modifies the dispensing cap according to the above-mentioned Hungarian utility model 30-U introducing a signaling element in the part of cap on the neck of bottle, which breaks and falls out when the cap is unscrewed. It does not prevent from partial dispensing of liquid but shows unauthorized opening of connection between the bottle and dispensing head.

The solution of the present application aims to develop a flat or low dispensing cap for soft drink bottles being sufficiently cheap to be disposable and protecting against unauthorized opening of bottle, as well as partial dispensing of liquid.

The solution is based on the creative recognition that the cap should consist of one part without complementing elements in order to be cheap enough to be disposable. It may be molded or die-cast in a single mold. The mold is complicated causing higher cost once but the assembly cost is reduced. Another creative recognition establishing the solution is that preventing pressing down the dispensing unit may eliminate unauthorized usage. If the preventing part is taken away the packaged product is obviously not untouched.

A further creative recognition is that the lower fixing part on the neck of bottle, the covering part thereon and the fixing member preventing dispensing should be made connectedly as one piece then all envisaged tasks are fulfilled and a new result not following from the state of art is reached.

The inventive solution based on the mentioned recognition is a dispensing cap for bottles consisting of a lower mounting part on the neck of bottle an upper part comprising the dispensing details such as valve and opening members sealing elements providing gas-proof sealing of the bottle and the cap an outlet for pouring the liquid out tube support holding the tube of siphon structure and other known completing elements if necessary. The dispensing cap according to application has the characteristic feature that it contains an irreversibly removable fixing member preventing dispensing.

The dispensing cap described in the application has the advantageous characteristic feature that the fixing part the covering part and the fixing member are joined together and assembled into cap by any known joining structure.

The dispensing cap described in the application has another advantageous characteristic feature that the outlet consists of an outlet base belonging to the mounting part and an outlet over belonging to the covering part, furthermore the valve and the opening members consist of a valve case belonging to the mounting part and a valve belonging to the covering part.

The dispensing cap described in the application has a further advantageous characteristic feature that the covering part is provided with a holding tube surrounding the valve case and not reaching its upper level and the fixing part is in the outlet attached to its upper outer end by a once breakable joint passing under the holding tube being supported by the valve case where the advantageously forked end of the fixing member surrounds the valve.

The dispensing cap described in the application has a further advantageous characteristic feature that the mounting part comprises a cylindrical shell tightly seating on the neck of bottle having an inwardly directed fixing flange on its lower end, which joins permanently under the outside flange of the neck of bottle after mounting.

The dispensing cap described in the application has a further advantageous characteristic feature that the mounting part is provided with a flange elastically seating from outside to the neck of bottle and a sealing stub entering the mouth of bottle and elastically seating from inside to it.

The dispensing cap described in the application has a further advantageous characteristic feature that the mounting part is provided with an upward directed collar on its border seating in the groove formed by the cover wall and the parallel downward directed inner wall of the cover in order to improve closing and sealing.

An advantageous embodiment of the dispensing cap according to application has a characteristic feature that a diaphragm is shaped by reducing the thickness of the top of cover around the valve and it is surrounded expediently wholly or in part with a projection.

Another advantageous embodiment of the dispensing cap according to application has a characteristic feature that dowel holes are formed in the mounting part and dowel pins entering the dowel holes are formed in the cover to join permanently together the lower and upper parts of the dispensing cap. Finally, the dispensing cap according to application has the advantageous characteristic feature that the mounting part the cover and the fixing member constitute one piece i.e. they are connected in the process of manufacturing. The invention for which protection is sought is described below using the attached figures but without any limitation to the applicability of the solution or the extent of protection to the shown examples of embodiment.

### FIGURES

FIG. 1: Lateral section of an advantageous construction of the dispensing cap according to application.

FIG. 2: Section of the dispensing cap shown in the FIG. 1 along II-II.

FIG. 3: A simplified view of the dispensing cap shown in the FIG. 1 from the side of outlet.

FIG. 4: Schematic drawing of an advantageous embodiment of the dispensing cap according to application in extended state before closing.

FIG. 5: Schematic drawing of the connection between the cover and the fixing member.

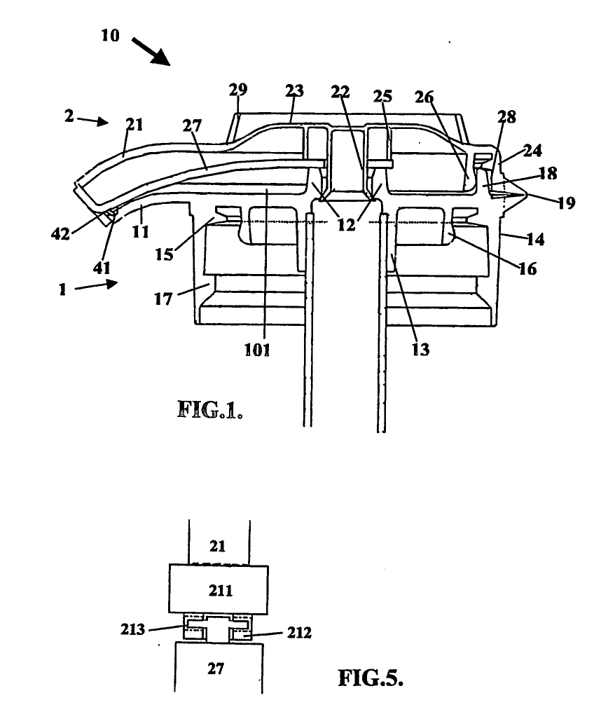

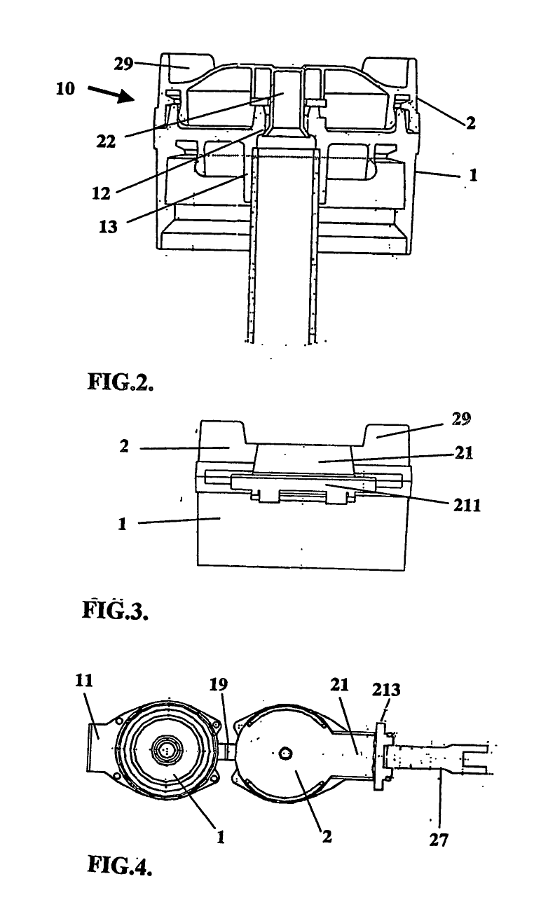

The dispensing cap 10 consists of a mounting part 1 and a cover 2 having a fixing member 27 inside (see FIGS. 1 and 2). The mounting part 1 is substantially a hollow cylindrical body comprising the outlet base 11 for pouring out the liquid and being closed by a disc 101 with a hole in the center. The cover 2 containing the outlet over 21 is a part completing and closing from above the mounting part 1 (see FIG. 3). As shown, the dispensing cap 10 consists of two connected precisely matching parts. The FIG. 4 shows that parts of the dispensing cap 10 are manufactured connected together as one piece. The mounting part 1 the cover 2 and the fixing member 27 are shown in the FIG. 4 from left to right. The dispensing cap 10 is formed in such a way that the fixing member 27 is folded into the cover 2 then the latter is folded onto the mounting part 1 and fixed. The detailed description is as follows. The mounting part 1 of the dispensing cap 10 has a flange 15 surrounding the neck of bottle and tightly seating from outside on it inside the cylindrical wall 14. A sealing stub 16 being projection of the disc 101 closing the cylindrical wall 14 seats tightly to the neck of bottle from inside. The disc 101 has a circular opening with an upward projection in its center forming a valve case 12 and a valve seat on the lower side. The coaxial to the valve case 12 ring-shaped tube support 13 has larger diameter than the valve case 12 and projects downwards from the disc 101. A fixing flange 17 is in the lower part of the mounting part 1, and the dispensing cap 10 may be permanently fixed onto the bottle by snapping the fixing flange 17 under the circular projection on the neck of bottle. The mounting part 1 is rigidly fixed and positioned on the neck of bottle by the fixing flange 17 the flange 15 and the sealing stub 16. The rigidity should be understood however according to elasticity of plastic.

The cover 2 is connected to the mounting part 1 by a connective piece 19. The connective piece 19 is either a plastic strip designed for folding or any other known foldable part (e. g. a plaited structure). A thin relatively elastic diaphragm 23 shaped by reducing the thickness closes the top of the cover except for a circular ring on its border. A hollow slightly flaring valve 22 coaxial with and precisely fitting to the valve case 12 projects from the center of the diaphragm 23 downward. The flaring lower flange of the valve 22 seats on the valve seat shaped on the lower part of the disc 101. The valve 22 is in elevated position held by the diaphragm 23 and by gas pressure when the bottle is filled with aerated soft drink, its lower flange closes tightly the valve case 12. When the diaphragm 23 is pressed down, the valve 22 moves downwards and opens the valve case 12 to let the liquid out. A rigid projection 29 protrudes on the top of the cover 2 either in three fourth of circle around the diaphragm 23 or at least on both sides of the diaphragm 23 to protect it against unintended pressing down. The main part of the cover 2 is the cover wall 24 having shape of an almost whole circle interrupted only by the outlet over 21 making the cover wall 24 shorter than a whole circle. The cover 2 has the same thickness in the ring around the diaphragm 23 as the cover wall 24. The inner wall 26 projects from this ring downwards parallel to the cover wall 24 in the cover 2 except for the section of outlet over 21. The cover wall 24 and the inner wall 26 form a groove 28 receiving the collar 18. This structure connects and tightly binds the mounting part 1 and the cover 2 with labyrinth connection. A holding tube 25 forming a short stub projects from the diaphragm downwards and is supported by the fixing member 27 in the cover 2. The fixing member 27 enters from the outer end of outlet over 21 up to the center of the cover 2 and its forked end surrounds the valve 22 from three sides above the valve case 12. The fixing member 27 is connected with the outer upper end of the outlet over 21 through a hinge structure. A flat hinge joint 211 is connected to the outer upper end of the outlet over 21 along a line. It may be bent relatively to or torn from the outlet over 21. The hinge joint 212 (see FIG. 5) has rectangular shape with two hinges 212 on the one side. The length of the rectangle is greater than the width of outlet over 21 and the width of rectangle is equal to the height (quasi height) of the outlet over opening consequently the hinge joint 211 closes the outlet opening. The holes of hinges 212 are on a common straight line. There are hinge bolts 213 on both sides of the one end of the fixing member 27 entering into the holes of the hinges 212 constituting the hinge structure. The other end of the fixing member is enlarged and forms the mentioned forked shape.

When the diaphragm 23 is pressed down the holding tube 25 is stopped by the fixing member 27 and the fixing member 27 is held by the top of the valve case 12 the diaphragm 23 is prevented against pressing down in this way. While the fixing member 27 is in its place the opening of bottle is prevented both at the valve 22 and at the outlet. The hinge joint 211 is broader than the outlet so it may be easily caught from both sides with two fingers. The hinge joint 211 joins the outlet over 21 along a line with thinned or perforated joint and may be torn without damaging the outlet. When the hinge joint 211 is torn from the end of outlet over 21 the fixing member 27 may be drawn out and disposed. The dispensing cap 10 may be used not only for closing the bottle but also for dispensing the liquid from it. It is advantageous if the color of the hinge joint 211 is different from that of the cover 2 in consequence thereof it appears obviously that the bottle Is not in the original state i. e. it has been already opened and used. The hinge joint 211 being wider than the outlet is however so apparent that it fulfills perfectly this task even having she same color.

The dowel holes 41 on the four points of the mounting part 1 and the dowel pins 42 entering them serve for the safe joint of the mounting part by snapping the latter ones into the dowel holes 41 by hand establishing permanent joint. The number of dowel holes 41 and dowel pins 42 may be increased in reasonable limits according to necessity. The mounting part 1 and the cover 2 may be permanently joined by any other known method without any influence on the extent of protection sought by the present application.

All the three parts of the dispensing cap 10 i. e. the mounting part 1 the cover 2 and the fixing member 27 joined together are advantageously manufactured in a single process using a single mold. The manufacturing process has the advantage that the parts of the dispensing cap are made surely of the same material and all the parameters of manufacturing i. e. temperature, pressure their change in the time and all other ones are the same. Another advantage is that all the parts are received together. It is possible to manufacture separately the parts and assemble them thereafter but the fact that the dispensing cap does not consist of parts occasionally selected from different sets makes the assembly process faster and the reliability and the quality of product higher. Even the assembly process being part of manufacturing becomes easier, faster and more reliable when the connected parts should be folded and snapped together by simple movements. The manufacturing in a single mold makes the dispensing cap so cheap as the cost of any simple cap being unable to dispense. The reuse i. e. the required storage and the demanding and expensive cleaning and disinfection of caps become unnecessary in this way. Summing up what has been said the invention described in the application relates to a dispensing cap having new characteristic features such as the securing insert and the assembly of upper and lower parts manufactured together in one mold of the dispensing cap.

The dispensing cap described in the application provides solution to the problem completely unsolved up to now in this field, because there has not been any safety device for flat dispensing caps or rather for all types of dispensing caps preventing or indicating dispensing from the original bottle even once or of a small quantity.

The solution according to invention can provide a dispensing cap having small dimensions and a price adequate for the usage once and also largely fulfilling the hygienic requirements.

1. A dispensing cap for bottles consisting of a lower mounting part fixed onto neck of bottle, an upper covering part containing the dispensing parts such as valve and opening members, sealing elements between the cap and the bottle for gas-proof sealing, outlet for pouring liquid, tube support for holding the tube of siphon structure, an irreversibly removable fixing member preventing dispensing and known completing elements if necessary, characterized by that its outlet consists of an outlet base (11) belonging to the mounting part (1) and an outlet over (21) belonging to the cover (2), furthermore the opening elements consist of a valve case (12) belonging to the mounting part (1), and a valve (22) belonging to the cover (2), wherein the cover (2) is provided with a holding tube (25) surrounding the valve case (12), but does not reach the upper level of the valve case (12), the fixing member (27) is in the outlet and having an once breakable joint to the upper outer end of the outlet over (21), passing under the holding tube (25), being supported by the valve case (12) and its—preferably forked—end surrounds the valve (22).

2. The dispensing cap according to claim 1 characterized by that the mounting part (1), the cover (2), and the fixing member (27) are joined together and assembled into dispensing cap (10) using any known connecting structure, like dowel holes (41) are formed in the mounting part (1) and dowel pins (42) entering the dowel holes (41) are formed in the cover(2) to join permanently together the lower and upper parts of the dispensing cap (10).

3. The dispensing cap according to claim 1 characterized by that the mounting part (1) comprises a cylindrical shell tightly seating on the neck of bottle having an inwardly directed fixing flange (17) on its lower end, which joins permanently under the outside flange of the neck of bottle after mounting.

4. The dispensing cap according to claim 1 characterized by that the mounting part (1) is provided with an inwardly directed flange (15) elastically seating from outside to the neck of bottle and a sealing stub (16) entering the mouth of bottle and elastically seating from inside to it.

5. The dispensing cap according to claim 1 characterized by that the mounting part (1) is provided with an upward directed collar (18) on its border seating in the groove (28) formed by the cover wall (24) and the parallel downward directed inner wall (26).

6. The dispensing cap according to claim 1 characterized by that a diaphragm (23) is shaped by reducing the thickness of the top of cover (2) around the valve (22) and complemented with a projection (29) surrounding it partly or wholly.

7. The dispensing cap according to claim 1 characterized by that the mounting part (1), the cover (2), and the fixing member are manufactured as one piece i. e. they are connected in the process of manufacturing.

8. The dispensing cap according to claim 1 characterized by that a diaphragm (23) is shaped by reducing the thickness of the top of cover (2) around the valve (22) and complemented with a projection (29) surrounding it partly or wholly.

9. The dispensing cap according to claim 1 characterized by that dowel holes (41) are formed in the mounting part (1) and dowel pins (42) entering the dowel holes (41) are formed in the cover (2) to join permanently together the lower and upper parts of the dispensing cap (10).

10. The dispensing cap according to claim 1 characterized by that the mounting part (1) the cover (2) and the fixing member are manufactured as one piece i. e. they are connected in the process of manufacturing.
